(19) United States
(12) Patent Application Publication
(10) Pub. No.: US 2010/0197843 A1
(43) Pub. Date: Aug. 5, 2010

(54) Composites Comprising a Polymer and a Selected Layered Compound and Methods of Preparing and Using Same

(75) Inventors: Jose M. Sosa, Deer Park, TX (US); Luyi Sun, Pearland, TX (US); Billy Ellis, Georgetown, TX (US)

Correspondence Address: FINA TECHNOLOGY INC, PO BOX 674412, HOUSTON, TX, 77267-4412, US

(73) Assignee: Fina Technology,Inc., Houston, TX (US)

(21) Appl. No.: 12/365,113

(22) Filed: Feb. 3, 2009

(51) Int. Cl. C08K 9/00; C08K 5/16; C08K 5/098; C08K 5/101; C08K 3/34

(52) U.S. Cl. 524/236; 524/397; 524/320; 524/445

(57) ABSTRACT

A method of producing a polymer and layered compound composition having a high degree of exfoliation of the layered compound is disclosed. The layered compound is treated with chemicals having an affinity with the polymer or the monomer of the polymer. The monomer and the layered compound can be combined prior to polymerization. The polymer and layered compound can be combined by solution mixing in a solvent. The layered compound can also be incorporated into the mixture by compounding a polymer product with the layered compound.

### CROSS-REFERENCE TO RELATED APPLICATIONS

Not applicable.

### FIELD

This disclosure relates to composites comprising a polymer and a layered compound and methods of making and using same. More specifically, this disclosure relates to methods of exfoliating layered compounds to prepare polymer composites.

### BACKGROUND

Polymeric materials are commonly found in many products, including food storage, medical devices, and automobiles. Nanocomposites comprise polymeric materials and inorganic layered compounds, such as clay. When these inorganic layered components are properly incorporated into a polymer matrix, significant improvements in physical and mechanical properties can be displayed. The extent of uniformity of the layered compound incorporated into the polymer matrix influences the characteristics of the nanocomposite.

A high degree of intercalation (the inserting of a molecule, or group of molecules, between a layer of clays) and exfoliation (the delamination of layered materials into disordered layers or sheets) are desired in order to achieve proper incorporation of inorganic layered compounds into a polymer matrix. In order to achieve a high degree of intercalation and exfoliation, the clays can be treated by some organic chemicals to increase their surface hydrophobicity and interlayer distances. These clays are referred to as organoclays.

In some instances, however, higher hydrophobicity and larger interlayer space do not necessarily lead to a higher degree of intercalation/exfoliation. Thus, there remains a need in the art to achieve higher degrees of intercalation and exfoliation than that provided by a higher hydrophobicity and larger interlayer space.

### SUMMARY

The present invention includes a method for production of a polymeric composite having improved intercalated/exfoliated morphology and articles made from such polymeric composite. The method includes combining a monomer with a layered compound to form a mixture and subjecting the mixture to polymerization conditions to produce a polymeric composite. The layered compound having been treated with an organic compound to produce a treated layered compound having an affinity with the monomer prior to combining with the monomer. The polymeric composite can have an intercalated morphology or can have an exfoliated morphology or both. The polymeric composite can have a greater degree of exfoliation when compared to an otherwise similar composite prepared in the absence of the layered compound treated with chemicals having an affinity with the monomer.

The treated layered compound can have an organic group having a solubility parameter that has less than 3.0 (MPa^{1/2}) difference than the solubility parameter of the monomer. The treated layered compound can have an organic group that comprises at least one hydrocarbon ring group, at least one methacrylate group, or combinations thereof.

The treating of the layered compound and subsequent polymerization may increase the interlayer distance of the layered compound by at least 5 angstroms

The layered compound can be treated by ion exchange with an organic cation to produce an organoclay, can have one or more benzyl group, and can have the structure of:

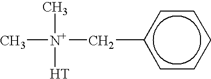

where HT is Hydrogenated Tallow (˜65% C₁₈; ˜30% C₁₆; ˜5% C₁₄)

The layered compound can be selected from the group consisting of natural clay, synthetic clay, sols, colloids, gels, fumes, or combinations thereof. The layered compound can be bentonite, montmorillonite, hectorite, fluorohectorite, saponite, stevensite, nontronite, sauconite, glauconite, vermiculite, chlorite, mica, hydromica, muscovite, biotite, phlogopite, illite, talc, pyrophillite, sepiolite, attapulgite, palygorskite, berthierine, serpentine, kaolinite, dickite, nacrite, halloysite, allophane, imogolite, hydrotalcite, pyroaurite, calcite, wollastonite, or combinations thereof.

The monomer can contain an aromatic moiety and an unsaturated alkyl moiety, and can be selected from the group consisting of styrene, alphamethyl styrene, t-butylstyrene, p-methylstyrene, acrylic and methacrylic acids or substituted esters of acrylic or methacrylic acid, vinyl toluene or combinations thereof. The monomer can be present in an amount of from 50 wt % to 99.9 wt % and the layered compound is present in an amount of from 0.1 wt % to 50 wt % of the mixture.

An additive can be added to the mixture, the additive selected from the group consisting of zinc dimethacrylate, stearyl methacrylate, hydroxyethylmethacrylate or combinations thereof. The additive can be present in the mixture in the range of 0.01 wt % to 10.0 wt %.

A comonomer and/or an elastomer can be added to the mixture, each in amounts from 0.1 wt % to 50 wt % by total weight. The elastomer can comprise a conjugated diene monomer, 1,3-butadiene, 2-methyl-1,3-butadiene, 2 chloro-1,3 butadiene, 2-methyl-1,3-butadiene, 2 chloro-1,3-butadiene, aliphatic conjugated diene monomer, C₄ to C₉ dienes butadiene, or combinations thereof.

The polymeric composite can be oriented to produce an oriented composite, wherein orienting the composite comprises stretching, spinning, blowing, casting, or combinations thereof in the machine direction, or in the transverse direction, or both.

In an alternate embodiment the polymeric composite is produced by a method of compounding a polymer with a layered compound to form a polymeric composite; wherein the layered compound has been treated with chemicals having an affinity with the polymer. The polymeric composite can have a greater degree of exfoliation when compared to an otherwise similar composite prepared in the absence of the layered compound treated with chemicals having an affinity with the monomer.

The polymer can be formed from monomers having an aromatic moiety and an unsaturated alkyl moiety. The polymer can be a styrenic polymer that optionally comprises one or more copolymers. The compounding of the layered compound with the polymer may increase the interlayer distance of the layered compound by at least 5 angstroms.

The treated layered compound can have an organic group having a solubility parameter that has less than 3.0 (MPa^{1/2}) difference than the solubility parameter of the polymer. The treated layered compound can have an organic group that comprises at least one hydrocarbon ring group, at least one methacrylate group, or combinations thereof.

In yet another embodiment the present invention includes a polymer nanocomposite composition and articles made from it. The polymer nanocomposite composition includes a polymer and a layered compound, the layered compound having been treated with chemicals having an affinity with the polymer.

When inorganic clays used in the nanocomposite are treated with an intercalating agent to produce organoclays, a higher degree of intercalation/exfoliation can be achieved by using an intercalating agent with an affinity with the monomer/polymer.

An embodiment of the present invention is directed towards a method to achieve exfoliation comprising in situ polymerization of styrene monomer with an organoclay, where the organoclay is treated by chemicals having an affinity with styrene. An embodiment of the invention is directed towards a method to achieve exfoliation by compounding polystyrene with an organoclay, where the organoclay is treated by chemical having an affinity with styrene/polystyrene. An embodiment of the invention is directed towards a method to achieve exfoliation by solution mixing of styrene monomer with an organoclay, which is treated by the chemicals having an affinity with styrene.

The present invention is also directed to compositions containing a percentage of organoclay that was intercalated by the chemicals having an affinity with styrene/polystyrene, and to articles made from such compositions.

### BRIEF DESCRIPTION OF THE DRAWINGS

FIG. 1 represents the composition and various properties of some organoclays commercially available from Southern Clay Products, Inc.

FIG. 2 represents a method of preparing a layered compound/polymer composite involving extrusion compounding.

FIGS. 3 and 4 represent the effect of the presence of clay on the time of polymerization.

FIG. 5 represents the X-ray diffraction patterns wherein the clay utilized in the in situ polymerization was CLOISITE 10A.

FIG. 6 represents the X-ray diffraction patterns wherein the clay utilized in the in situ polymerization was CLOISITE 20A.

FIG. 7 represents an X-ray diffraction pattern of CLOISITE 10A and polystyrene nanocomposites prepared from a compounding approach.

FIG. 8 represents an X-ray diffraction pattern of CLOISITE 15A and polystyrene nanocomposites prepared from a compounding approach.

### DETAILED DESCRIPTION

Disclosed herein are layered compound/polymer composites (LCPCs) comprising one or more layered compounds and one or more polymeric materials and methods of making and using the same. The LCPC is a nanocomposite, and herein “nanocomposites” refer to materials that are created by introducing nanoparticles with at least one dimension less than 100 nanometers (nm), also called filler materials (e.g., a layered compound) into a macroscopic material (e.g., polymeric material), which is commonly referred to as the matrix. According to the embodiments of the invention, the LCPC comprises a nanocomposite having a layered filler material (also referred to as a nanofiller) and a polymer matrix.

The LCPC comprises a layered compound. The layered compounds can include natural and synthetic clay, sols, colloids, gels, fumes, and the like. Such compounds may comprise nanoparticulates, which are small particles with at least one dimension less than 100 nanometers (nm). In an embodiment, the LCPC comprises clay. In accordance with this disclosure, clays refer to aggregates of hydrous silicate particles either naturally occurring or synthetically produced, and may consist of a variety of minerals rich in silicon and aluminum oxides and hydroxides which include variable amounts of other components such as alkali earth metals and water. Naturally occurring clays are usually formed by chemical weathering of silicate-bearing rocks, although some are formed by hydrothermal activity. These types of clays can be replicated in industrial chemical processes. Many types of clay have sheet-like (layered) structures and these layers are typically referred to as platelets. These platelets have a degree of flexibility with a thickness on the order of 1 nm and aspect ratios of 50 to 1500.

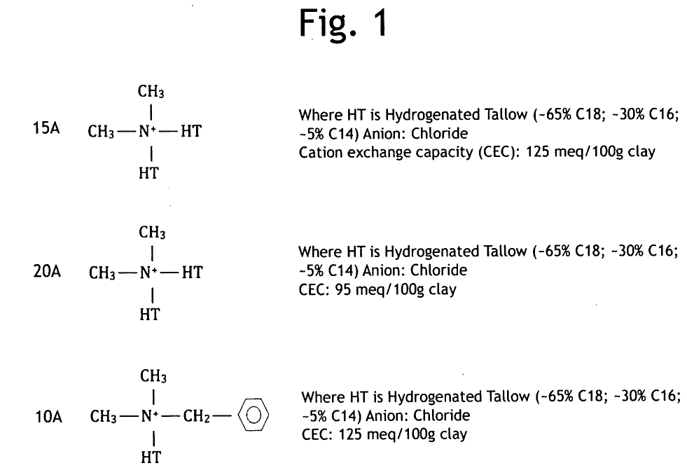

The clays used in an embodiment of the present invention are organophilic and such clays are typically referred to as organoclay. Organoclay is an organically modified silicate compound that is derived from natural or synthetic clay. Organoclay can be produced from clays that are typically hydrophilic by ion exchange with an organic cation. Some examples of layered materials suitable as components in organoclays include without limitation natural or synthetic bentonite, montmorillonite, hectorite, fluorohectorite, saponite, stevensite, nontronite, sauconite, glauconite, vermiculite, chlorite, mica, hydromica, muscovite, biotite, phlogopite, illite, talc, pyrophillite, sepiolite, attapulgite, palygorskite, berthierine, serpentine, kaolinite, dickite, nacrite, halloysite, allophane, imogolite, hydrotalcite, pyroaurite, calcite, wollastonite, or combinations thereof. Examples of an organoclay suitable for use in this disclosure include without limitation CLOISITE 10A, CLOISITE 15A, and CLOISITE 20A, which are commercially available from Southern Clay Products, Inc. and are described in further detail in FIG. 1. The relative surface hydrophobicity of these organoclays are: CLOISITE 10A<CLOISITE 20A<CLOISITE 15A.

In embodiments of the invention, the organoclay may be present in an amount of from 0. 1 weight percent (wt. %) to 50 wt. %, alternatively from 0.5 wt. % to 25 wt. %, or from 1 wt. % to 10 wt. %.

In accordance with the invention, the LCPC comprises a polymer. The polymer may be present in the LCPC in an amount of from 50 wt. % to 99.9 wt. %, or from 90 wt. % to 99.5 wt. %, or from 95 wt. % to 99 wt. % based on the total weight of the LCPC.

In an embodiment, the polymer can be formed from monomers having a phenyl benzyl group. More specifically, the polymer can be formed from monomers having an aromatic moiety and an unsaturated alkyl moiety. Such monomers may include monovinylaromatic compounds such as styrene as well as alkylated styrenes wherein the alkylated styrenes are alkylated in the nucleus or side-chain. Alphamethyl styrene, t-butylstyrene, p-methylstyrene, acrylic and methacrylic acids or substituted esters of acrylic or methacrylic acid, and vinyl toluene are suitable monomers that may be useful in forming a polymer of the invention. These monomers are disclosed in U.S. Pat. No. 7,179,873 to Reimers et al., which is incorporated by reference in its entirety.

The polymeric component in the LCPC can be a styrenic polymer (e.g., polystyrene), wherein the styrenic polymer may be a homopolymer or may optionally comprise one or more comonomers. Styrene, also known as vinyl benzene, ethenylbenzene, phenethylene and phenylethene is an aromatic organic compound represented by the chemical formula C₈H₈. Styrene is widely commercially available and as used herein the term styrene includes a variety of substituted styrenes (e.g. alpha-methyl styrene), ring substituted styrenes such as p-methylstyrene, distributed styrenes such as p-t-butyl styrene as well as unsubstituted styrenes.

In an embodiment, the styrenic polymer has a melt flow as determined in accordance with ASTM D1238 of from 1.0 g/10 min to 30.0 g/10 min, alternatively from 1.5 g/10 min to 20.0 g/10 min, alternatively from 2.0 g/10 min to 15.0 g/10 min; a density as determined in accordance with ASTM D1505 of from 1.04 g/cc to 1.15 g/cc, alternatively from 1.05 g/cc to 1.10 g/cc, alternatively from 1.05 g/cc to 1.07 g/cc, a Vicat softening point as determined in accordance with ASTM D1525 of from 227° F. to 180° F., alternatively from 224° F. to 200° F., alternatively from 220° F. to 200° F.; and a strength as determined in accordance with ASTM D638 of from 5800 psi to 7800 psi. Examples of styrenic polymers suitable for use in this disclosure include without limitation CX5229 and PS535, which are polystyrenes commercially available from Total Petrochemicals USA, Inc. In an embodiment the styrenic polymer (e.g., CX5229) has generally the properties set forth in Table 1.

TABLE 1

| | Typical Value | Test Method |
|---|---|---|
| Physical Properties | | |
| Melt Flow, 200/5.0 g/10 m | 3.0 | D1238 |
| Tensile Properties | | |
| Strength, psi | 7,300 | D638 |
| Modulus, psi (10⁵) | 4.3 | D638 |
| Flexular Properties | | |
| Strength, psi | 14,000 | D790 |
| Modulus, psi (10⁵) | 4.7 | D790 |
| Thermal Properties | | |
| Vicat Softening, deg. F. | 223 | D1525 |

In some embodiments, the styrenic polymer further comprises a comonomer which when polymerized with styrene forms a styrenic copolymer. Examples of such copolymers may include for example and without limitation α-methylstyrene; halogenated styrenes; alkylated styrenes; acrylonitrile; esters of methacrylic acid with alcohols having 1 to 8 carbons; N-vinyl compounds such as vinylcarbazole and maleic anhydride; compounds which contain two polymerizable double bonds such as for example and without limitation divinylbenzene or butanediol diacrylate; or combinations thereof. The comonomer may be present in an amount effective to impart one or more user-desired properties to the composition. Such effective amounts may be determined by one of ordinary skill in the art with the aid of this disclosure. For example, the comonomer may be present in the styrenic polymer in an amount ranging from 0.1 wt. % to 99.9 wt. % by total weight of the LCPC, alternatively from 1 wt. % to 90 wt. %, and further alternatively from 1 wt. % to 50 wt. %.

In an embodiment, the polymer also comprises a thermoplastic material. Herein a thermoplastic material refers to a plastic that melts to a liquid when heated and freezes to form a brittle and glassy state when cooled sufficiently. Examples of thermoplastic materials include without limitation acrylonitrile butadiene styrene, celluloid, cellulose acetate, ethylene vinyl acetate, ethylene vinyl alcohol, fluoroplastics, ionomers, polyacetal, polyacrylates, polyacrylonitrile, polyamide, polyamide-imide, polyaryletherketone, polybutadiene, polybutylene, polybutylene terephthalate, polychlorotrifluoroethylene, polyethylene terephthalate, polycyclohexylene dimethylene terephthalate, polycarbonate, polyetherimide, polyethersulfone, polyethylenechlorinate, polyimide, polylactic acid, polymethylpentene, polyphenylene oxide, polyphenylene sulfide, polyphthalamide, polypropylene, polysulfone, polyvinyl chloride, polyvinylidene chloride, and combinations thereof For example, the thermoplastic material may be present in the styrenic polymer in an amount ranging from 0.1 wt. % to 50 wt. % by total weight of the LCPC.

In an embodiment, the polymer comprises an elastomeric phase that is embedded in a polymer matrix. For instance, the polymer may comprise a styrenic polymer having a conjugated diene monomer as the elastomer. Examples of suitable conjugated diene monomers include without limitation 1,3-butadiene, 2-methyl-1,3-butadiene, and 2-chloro-1,3-butadiene. Alternatively, the thermoplastic may comprise a styrenic polymer having an aliphatic conjugated diene monomer as the elastomer. Without limitation, examples of suitable aliphatic conjugated diene monomers include C₄ to C₉ dienes such as butadiene monomers. Blends or copolymers of the diene monomers may also be used. Examples of thermoplastic polymers include without limitation acrylonitrile butadiene styrene (ABS), high impact polystyrene (HIPS), methyl methacrylate butadiene (MBS), and the like. The elastomer may be present in an amount effective to impart one or more user-desired properties to the composition. Such effective amounts may be determined by one of ordinary skill in the art with the aid of this disclosure. For example, the elastomer may be present in the styrenic polymer in an amount ranging from 0.1 wt. % to 50 wt. % by total weight of the LCPC, or from 1 wt. % to 25 wt. %, or from 1 wt. % to 10 wt. %.

In accordance with the invention, the LCPC also optionally comprises additives, as deemed necessary to impart desired physical properties. The additives used in the invention may be additives having different polarities. Additives suitable for use in the invention include without limitation Zinc dimethacrylate, hereinafter referred to as “ZnDMA”, Stearyl methacrylate, hereinafter referred to as “StMMA”, and Hydroxyethylmethacrylate, hereinafter referred to as “HEMA”.

These additives may be included in amounts effective to impart desired physical properties. In an embodiment, the additive(s) are included in amounts of from 0.01 wt. % to 10 wt. %. In another embodiment, when ZnDMA is the additive, it is present in amounts of from 0.01 wt. % to 5 wt. %. In another embodiment, when the additive is StMMA or HEMA, the additive is present in amounts of from 1 wt. % to 10 wt. %.

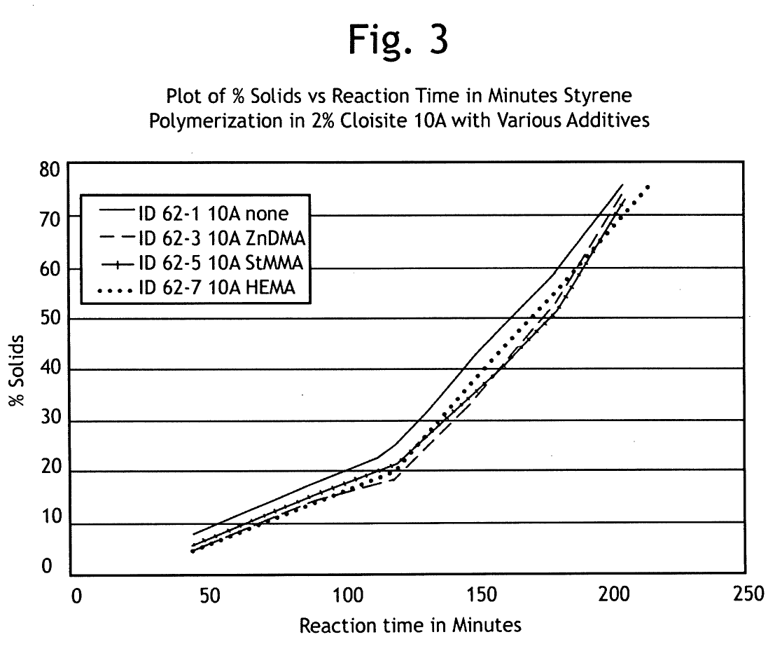

In accordance with the present invention, it has been found that the chemically treated clay, CLOISITE 10A, has an affinity with styrene monomers. Experiments were conducted comparing the amount of exfoliation of CLOISITE 10A and CLOISITE 20A. The results of the experiments concluded that a high degree of exfoliation can be achieved with CLOISITE 10A, but not with CLOISITE 20A. The results of the experiments are provided in further detail in the “Examples” section of this disclosure and in the FIGS. 3-8, provided herein.

In reference to FIG. 1, CLOISITE 20A contains all alkyl groups, two of which are hydrogenated tallow, hereinafter referred to as “HT” (HT comprises about 65% C₁₈; about 30% C₁₆; and about 5% C₁₄). Also in reference to FIG. 1, CLOISITE 10A contains a benzyl group. The present disclosure finds that CLOISITE 10A, having a benzyl group, exhibits good behavior with the benzyl structure of styrene. CLOISITE 10A was found to have more structures having a higher degree of exfoliation within a sample of LCPC comprising styrene polymer.

As used herein two materials have an affinity for each other if there is no more than 3.0 (MPa^{1/2}) difference between their solubility parameters. CLOISITE 10A contains a benzyl group, benzene having a solubility parameter of 18.8 (MPa^{1/2}) while styrene has a solubility parameter of 19.0 (MPa^{1/2}). The addition of the organic compound to the clay, in this instance the benzyl group, provides an affinity between the clay and the polymer, as the solubility parameter of the benzyl group is close to that of the styrene. Other hydrocarbon ring structures have solubility parameters that would impart an affinity for styrene, such as cyclohexane with a solubility parameter of 16.8 (MPa^{1/2}), cyclopentane with a solubility parameter of 17.8 (MPa^{1/2}), and cyclopentanone with a solubility parameter of 21.3 (MPa^{1/2}).

It has also been found that methacrylate groups provide an affinity between the clay and the polymer, as the solubility parameter of the methacrylate group is close to that of the styrene. As non-limiting examples butyl methacrylate with a solubility parameter of 16.8 (MPa^{1/2}), ethyl methacrylate with a solubility parameter of 17.0 (MPa^{1/2}), butyl methacrylate with a solubility parameter of 16.8 (MPa^{1/2}), and methyl methacrylate with a solubility parameter of 18.0 (MPa^{1/2}).

As non-limiting examples, Table 2 provides a listing of various ring structured groups and methacrylate groups that may be used to modify a layered compound to provide an affinity between the layered compound and the monomer or polymer that the layered compound is being dispersed into. Data in Table 2 is taken from the Polymer Handbook, 4'th edition by J. Brandrup, E. H. Immergut, and E. A Grulke, John Wiley & Sons, Inc., 1999.

TABLE 2

| | Solubility Parameter |
|---|---|
| Solvent | (MPa^{1/2}) |
| Butyl methacrylate | 16.8 |
| Cyclohexane | 16.8 |
| Ethyl methacrylate | 17.0 |
| Methyl styrene | 17.4 |
| Cyclopentane | 17.8 |
| Chlorotoluene | 18.0 |
| Ethylbenzene | 18.0 |
| Methyl methacrylate | 18.0 |
| Xylene (p-xylene) | 18.0 |
| Toluene | 18.2 |
| Vinyl toluene | 18.6 |
| Benzene | 18.8 |
| Methylcyclohexanone | 19.0 |
| Styrene | 19.0 |
| Furan | 19.2 |
| Chlorobenzene | 19.4 |
| Cyclohexanone | 20.3 |
| Dichlorobenzene | 20.5 |
| Nitrobenzene | 20.5 |
| Iodobenzene | 20.7 |
| Cyclopentanone | 21.2 |
| Cyclobutanedione | 22.5 |

In an embodiment, a method for production of the styrenic polymer comprises contacting styrene monomer and other components under proper polymerization reaction conditions. The polymerization process may be operated under batch or continuous process conditions. In an embodiment, the polymerization reaction may be carried out using a continuous production process in a polymerization apparatus comprising a single reactor or a plurality of reactors. In an embodiment of the invention, the polymeric composition can be prepared for an upflow reactor. Reactors and conditions for the production of a polymeric composition are disclosed in U.S. Pat. No. 4,777,210, to Sosa et al., which is incorporated by reference in its entirety.

The operating conditions, including temperature ranges, can be selected in order to be consistent with the operational characteristics of the equipment used in the polymerization process. In an embodiment, polymerization temperatures range from 90° C. to 240° C. In another embodiment, polymerization temperatures range from 100° C. to 180° C. In yet another embodiment, the polymerization reaction may be carried out in a plurality of reactors, wherein each reactor is operated under an optimum temperature range. For example, the polymerization reaction may be carried out in a reactor system employing a first and second polymerization reactors that are either both continuously stirred tank reactors (CSTR) or both plug-flow reactors. In an embodiment, a polymerization reactor for the production of a styrenic copolymer of the type disclosed herein comprising a plurality of reactors wherein the first reactor (e.g., a CSTR), also known as the prepolymerization reactor, operated in the temperature range of from 90° C. to 135° C. while the second reactor (e.g., CSTR or plug flow) may be operated in the range of 100° C. to 165° C.

The polymerized product effluent may be referred to herein as the prepolymer. When the prepolymer reaches a desired conversion, it may be passed through a heating device into a second reactor to achieve further polymerization. The polymerized product effluent from the second reactor may be further processed as desired or needed. Upon completion of the polymerization reaction, a styrenic polymer is recovered and subsequently processed, for example devolatized, pelletized, etc.

In accordance with the invention, the layered compound may be incorporated into the polymer/monomer at any stage of the polymerization process, for example, including without limitation before, during, or after the polymerization process. In an embodiment, the layered compounded is incorporated by solution mixing of a monomer with the layered compound. For example, by the mixing of styrene monomer with organoclay prior to in situ polymerization. In another embodiment, the layered compound is incorporated by compounding the polymerized product with a layered compound. For example, compounding polystyrene with an organoclay. In yet another embodiment, the layered compound is incorporated by solution mixing with a polymer, such as polystyrene, in a proper solvent, such as toluene or tetrahydrofuran. For example, solution mixing polystyrene with an organoclay in toluene.

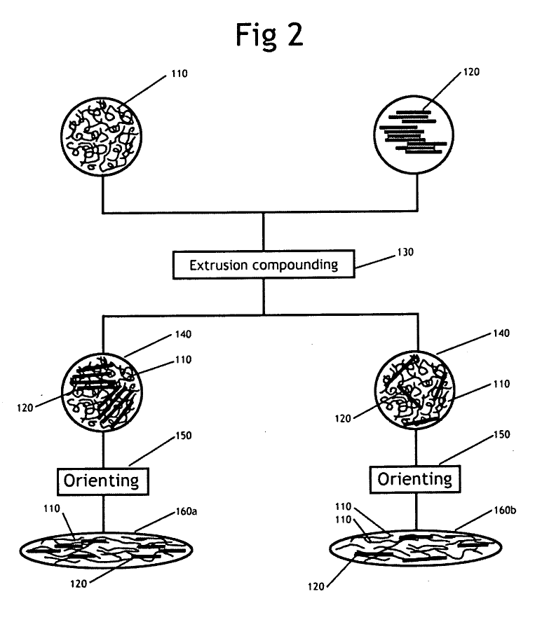

In an embodiment the layered compound is compounded with a polymer. In such an embodiment, in reference to FIG. 2, the method 100 may initiate by contacting of polymer 110 and layered compound 120 to form a mixture via extrusion compounding 130. Extrusion compounding 130 refers to the process of mixing a polymer with one or more additional components wherein the mixing may be carried out using a continuous mixer such as for example a mixer consisting of a short non-intermeshing counter rotating twin screw extruder or a gear pump for pumping.

In another embodiment, the polymerized product resulting from in situ polymerization of a monomer with a layered compound is subjected to extrusion compounding 130 to achieve further exfoliation and dispersion of the layered compound. In yet another embodiment, the nanocomposite product resulting from a mixed solution comprising a polystyrene and a layered compound, which is dried after solution mixing, can be subjected to extrusion compounding 130 to achieve further exfoliation and dispersion of the layered compound.

Extrusion compounding 130 may produce a composition in which some of the polymer has been intercalated into the layered compound as depicted in structure 140a. In structure 140a, the polymer 110 is inserted between platelets of the layered compound 120 such that the interlayer spacing of the layered compound 120 is expanded but still possess a well-defined spatial relationship with respect to each other. Extrusion compounding 130 may also result in some degree of exfoliation as shown in 140b in which the platelets of the layered compound 120 have been separated and the individual layers are distributed throughout the polymer 110. The mixture of layered compound and polymer after having been extrusion compounded is hereinafter referred to as the extruded mixture.

The method 100 for the preparation of the LCPC may then proceed to block 150 wherein the extruded mixture is oriented to produce the LCPC. The LCPC may be oriented using any suitable physical and/or mechanical techniques that change the dimensions of the composites. Generally, orientation of a polymer composition refers to the process whereby directionality (the orientation of molecules relative to each other) is imposed upon the composition. In some embodiments, the composition may be oriented using any suitable physical technique such as stretching, spinning, blowing, casting, or combinations thereof to produce films, fibers, tape, and the like. In an embodiment, the extruded mixture is uniaxially or biaxially oriented. As used herein, the term “biaxial orientation” refers to a process in which a polymeric composition is heated to a temperature at or above its glass-transition temperature but below its crystalline melting point. For example, the extruded mixture may be passed over a first roller (e.g. chill roller), which solidifies the polymeric composition (i.e. LCPC) into a film. Then, stretching the film in a longitudinal direction and in a transverse direction orients the film. The longitudinal orientation is generally accomplished through the use of two consecutively arranged rollers, the second (or fast roller) operating at a speed in relation to the slower roller corresponding to the desired orientation ratio. Longitudinal orientation may alternatively be accomplished through a series of rollers with increasing speeds, sometimes with additional intermediate rollers, which can aid in temperature control and other functions.

After longitudinal orientation the film may be cooled, pre-heated and passed into a lateral orientation section. The lateral orientation section may include, for example, a tenter frame mechanism, where the film is stressed in the transverse direction. Annealing and/or additional processing may follow such orientation. In an alternative embodiment, the film may be stretched in both directions at the same time.

Without wishing to be limited by theory, on cooling the molecular alignment imposed by stretching competes favorably with crystallization, and the drawn polymer molecules condense into a crystalline network with crystalline domains aligned in the direction of the stretching force. Additional disclosure on biaxial film production may be found in U.S. Pat. No. 4,029,876 to Beatty et al. and U.S. Pat. No. 2,178,104 to Kline et al., each of which is incorporated by reference herein in its entirety.

In an embodiment, an article constructed from an LCPC containing a layered compound having an increased affinity with the polymer/monomer showed an improvement in both flexural modulus and Young's modulus, compared to the polymer lacking the layered compound. Young's modulus is a measure of the stiffness of a material and is defined as the ratio of the rate of change of stress with strain. Young's modulus can be determined experimentally from the slope of a stress-strain curve created during tensile tests conducted on a sample of a material, as determined in accordance with ASTM D882. In an embodiment, the article made from the LSPS may exhibit an increase in Young's modulus at yield when compared to a similar article constructed from a polymer lacking the layered compounds of from 5% to 300%, alternatively from 10% to 100%, alternatively from 20% to 50%. The flexural modulus is another measure of the stiffness of a material and is defined as the amount of applied force over the amount of deflected distance. The flexural modulus is measured in accordance with ASTM D790. In an embodiment, the article made from LCPC may exhibit an increase in tensile strength at yield when compared to a similar article constructed from a polymer that does not contain the layered compounds of from 5% to 300%, alternatively from 10% to 100%, alternatively from 20% to 50%.

The optical properties of the LCPC containing a layered compound are dependent upon the degree of dispersion of the layered compound. When the layered compound is well exfoliated and uniformly dispersed, the negative optical effect of the layered compound is minimal. Conversely, poor dispersion of the layered compound in the LCPC leads to a significant drop in the clarity of the LCPC.

In an embodiment, a biaxially oriented film produced from an LCPC of the type disclosed herein has a gloss 20° of from 10 to 90, or from 20 to 80, or from 30 to 70, and a gloss 60° of from 20 to 110, or from 30 to 100, or from 40 to 90. The gloss of a material is based on the interaction of light with physical characteristics of a surface of the material, more specifically the ability of such a surface to reflect light in a specular direction, as determined in accordance with ASTM D2457. Gloss can be measured by measuring the degree of gloss for example at 20° and 60° incident angles (also known as “gloss 20°” and “gloss 60°”, respectively).

### EXAMPLES

The following examples are given to illustrate embodiments of the present invention. Although it has been widely accepted that the surface hydrophobicity of the selected organoclay is very critical and is one of main determining factors for the final morphology, the following examples demonstrate that the affinity of the organoclays to the monomer or polymer are also very important. The organoclays with lower hydrophobicity could be better exfoliated as long as they possess a higher affinity with the polymer matrix or the monomers used to prepare polymer matrix. These examples are not intended to limit the scope of the present invention and should not be interpreted as limiting.

### Example 1

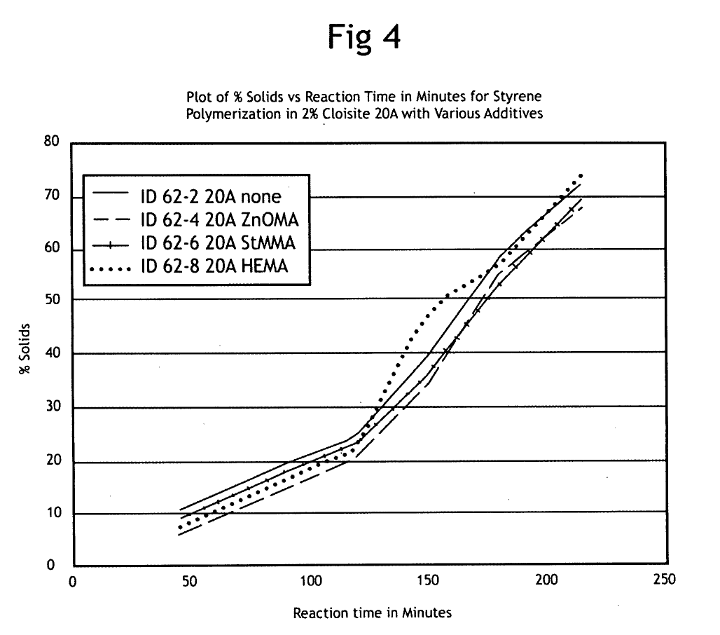

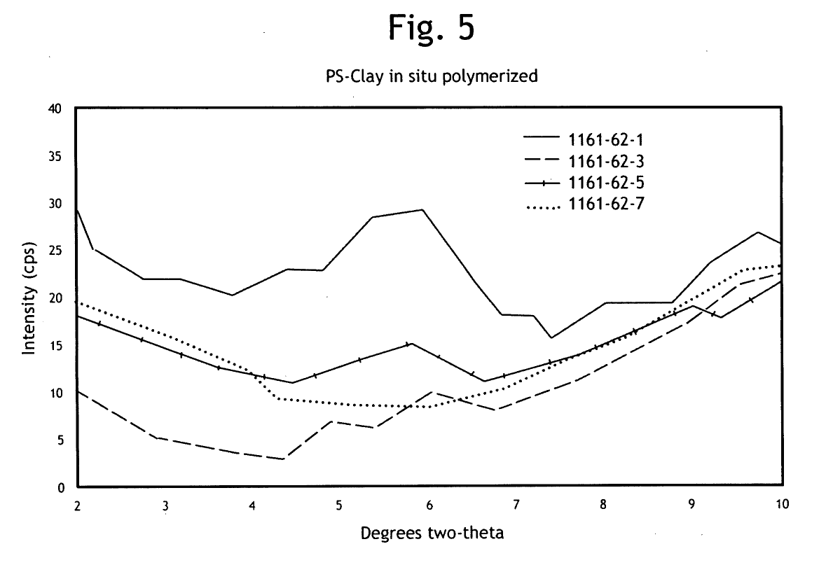

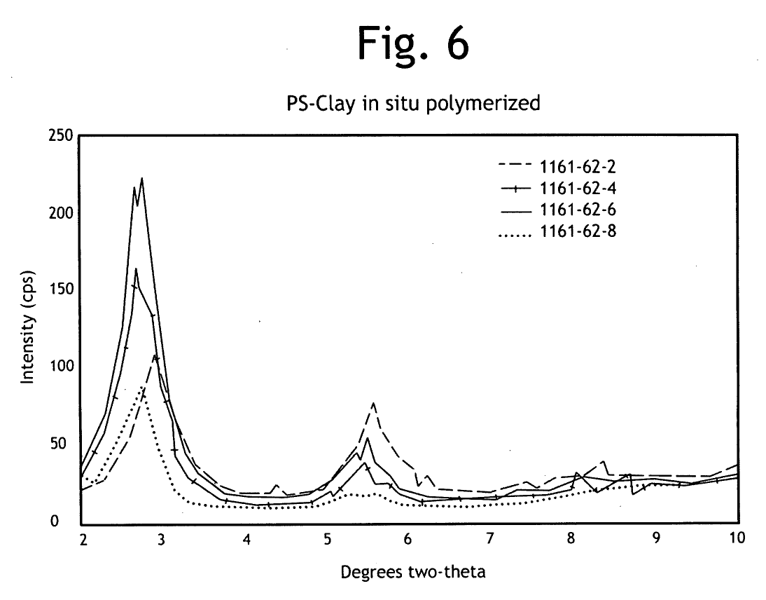

Eight experiments were carried out in a laboratory batch reactor. All batches were carried out in 500 ml reaction kettles under a nitrogen atmosphere using a temperature profile of 2 hrs at 110° C., 1 hr at 130° C., and 1 hr at 150° C. Styrene (200 g) was initiated with 150 ppm of Luperox® 531 and 75 ppm of Luperox® 233. A flat-blade agitator operating at 200 RPM was used to disperse organoclays and to stir the mixtures during the polymerization. In this example, dispersing techniques, such as ultrasonication and high shear mixers, were not used. The polymerization reactions were carried out to 65-70% solids. Samples were devolatized in a laboratory vacuum oven for 30 minutes at 225° C. and ˜1 Torr. Plaques were compression molded. The clays and additives used in each experimental run are shown in Table 3. FIGS. 3 and 4 show plots of % solids vs. reaction time. FIGS. 5 and 6 show X-ray diffraction patterns of devolatized samples.

FIGS. 3 and 4 show that the rate of polymerizations were acceptable and that the presence of clays did not create any significant problems for the reactions. Sample 8 with HEMA in the presence of CLOISITE 20A showed what appears to be autoacceleration, which is experienced when pure MMA is polymerized. Polymerizations in the presence of ZnDMA and StMMA were almost identical in either CLOISITE 10A or CLOISITE 20A. In FIG. 4, the curve in the line representing Sample 8 appears to be due to an anomaly in the testing data.

FIGS. 5 and 6 show the X-ray diffraction patterns for experiments utilizing CLOISITE 10A and CLOISITE 20A, respectively. According to the data obtained, near complete exfoliation was obtained with CLOISITE 10A with each of the three additives. However, when the clay utilized was CLOISITE 20A, complete exfoliation was not achieved. These results are new and unexpected, since high shear rates are typically required to completely exfoliate or separate the clay platelets. Further more, Cloisite 10A, which has a low surface hydrophobicity than Cloisite 20A, were better exfoliated than Cloisite 20A, which is because the chemicals used to treat it has higher affinity with polystyrene or styrene monomer. The affinity between Cloisite 10A and polystyrene is thought to be the primary reason that a high degree of exfoliation was achieved without imparting high shear rates.

### Example 2

Styrene compounds were prepared in the presence of two organoclays to determine the feasibility of producing reactor grades in the PS process. Table 3 is a summary of materials made, which includes the additives used, the final conversion, MFI and relative intensity of x-ray signal for the formulation with and without additives. Complete exfoliation should be represented by an intensity of near zero at 5.8 degrees. Thus, the relative intensity gives an estimation of the extent of exfoliation. Using this index, HEMA gives the best results with both clays. Commercially available polystyrene compounds PS 585 and PS 535 from Total Petrochemicals, Inc are also included.

TABLE 3
Summary of Experimental Polymerizations in the
Presence of Organoclays

| | 2 wt % Clay | | Final % | | Intensity |
|---|---|---|---|---|---|
| ID # | Loading | Additive* | Solids | MFI | Ratio** |
| PS535 | | | | 1.8 | |
| PS585 | | | | 4.0 | |
| Sample 1 | Cloisite (10A) | none | 75.9 | 1.44 | 1.0 |
| Sample 2 | Cloisite (20A) | none | 72.1 | 1.18 | 1.0 |
| Sample 3 | Cloisite (10A) | 0.1 wt % | 74.0 | 1.47 | 0.39 |
| | | ZnDMA | | | |
| Sample 4 | Cloisite (20A) | 0.1 wt % | 67.4 | 0.92 | 0.72 |
| | | ZnDMA | | | |
| Sample 5 | Cloisite (10A) | 2 wt % | 73.4 | 2.99 | 0.39 |
| | | StMMA | | | |
| Sample 6 | Cloisite (20A) | 2 wt % | 69.1 | 2.02 | 0.44 |
| | | StMMA | | | |
| Sample 7 | Cloisite (10A) | 2 wt % HEMA | 75.9 | 0.89 | 0.3 |
| Sample 8 | Cloisite (20A) | 2 wt % HEMA | 73.7 | 0.77 | 0.3 |

*Additives ZnDMA: Zinc dimethacrylate StMMA: Stearyl methacrylate HEMA: Hydroxyethylmethacrylate
**Intensity Ratio (5.8 degrees) = Intensity of peak with additive/Intensity of peak with no additive

### Example 3

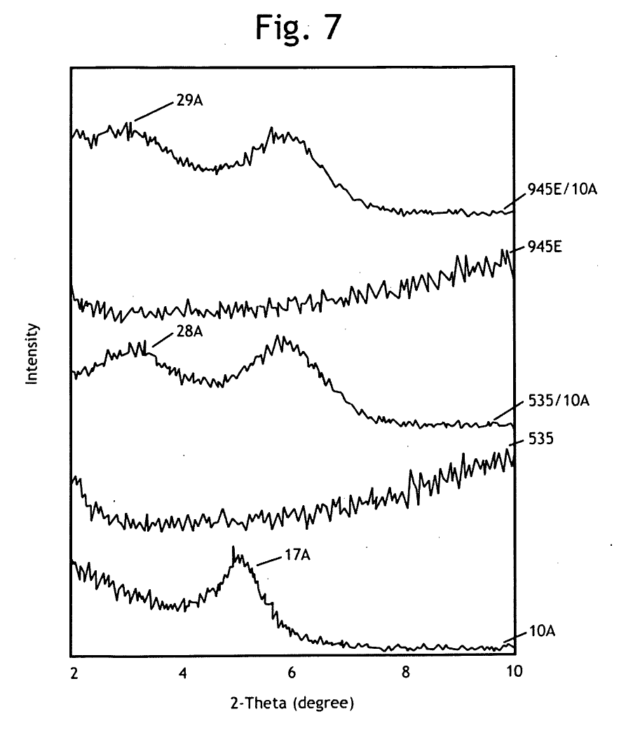

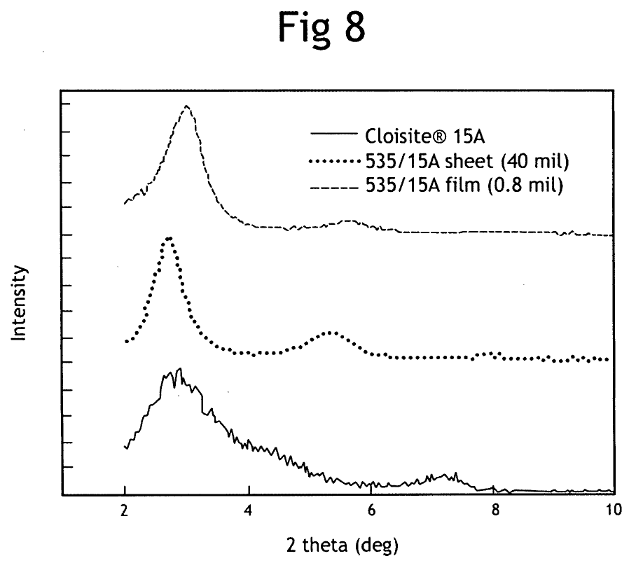

An organoclay, CLOISITE 10A, was compounded with two Total Petrochemicals polystyrene resins, GPPS 535 and HIPS 945E at a loading of 5.0 wt % on a twin-screw co-rotating extruder (Leistritz ZSE 50 GL, Length-to-diameter (L/D) ratio 36:1). After compounding CLOISITE 10A with polystyrene, the interlayer distance of CLOISITE 10A increased from 17 angstroms to about 28 angstroms, as shown in FIG. 7. This data indicates that the polystyrene chains have been successfully intercalated into the galleries of CLOISITE 10A. In contrast, when CLOISITE 15A was compounded with polystyrene under the same processing conditions, its interlayer distance only increased slightly as shown in FIG. 8. This result confirms that CLOISITE 10A, which was treated by a quaternary ammonium salt containing a benzyl group, is more compatible with polystyrene than CLOISITE 15A. As between the two polystyrene grades tested, HIPS 945E appears to perform slightly better than GPPS 535, as evidenced by the slightly larger interlayer distance and wider peak (see FIG. 7).

The mechanical testing results show that after the incorporation of CLOISITE 10A, both flexural modulus and Young's modulus increase. Such an increase is expected considering a combined intercalated and exfoliated morphology achieved in the polystyrene/CLOISITE 10A nanocomposites.

As summarized in Table 4, 945E/CLOISITE 10A nanocomposites exhibited approximately 15% improvement in both flexural modulus and Young's modulus, when compared to neat 945E resin. 535/CLOISITE 10A nanocomposites showed less of an improvement. This is consistent with their morphology as indicated by the XRD results shown in FIG. 7. The impact strength of the nanocomposites mainly depends on the morphology and dispersion state of the nanoplatelets in the polymer matrix. The reduced impact strength is commonly due to the formation of defects, especially on the interface of the nanoplatelets and polymer matrix.

TABLE 4
Mechanical Properties of Polystyrene Nanocomposites

| | Flexural | Young's | Tensile | | |
|---|---|---|---|---|---|
| | Modulus | Modulus | Strength @ | Elongation at | Izod Impact |
| | (kpsi) | (kpsi) | yield (psi) | break (%) | (Notched) |
| GPPS 535 | 469 | 445 | 7172 | 2.0 | 0.38 |
| GPPS 535/5% 10A | 505 | 475 | 6293 | 1.5 | 0.18 |
| Improvement (%) | 7.7 | 6.7 | −12.3 | −25 | −53 |
| HIPS 945E | 323 | 303 | 3577 | 55.3 | 2.91 |
| HIPS 945E/5% 10A | 372 | 347 | 3582 | 30.1 | 1.63 |
| Improvement (%) | 15.2 | 14.5 | 0.1 | −46 | −44 |

The optical properties of the polystyrene nanocomposites were also evaluated (see Table 5). The incorporation of 5.0 wt. % CLOISITE 10A into the polystyrene product reduced both the clarity and gloss of PS 535. However, in HIPS 945E, CLOISITE 10A increased the surface gloss slightly. In general, the clarity of the prepared polymer nanocomposites is mainly determined by the dispersion state of the layered compound. When the layered compound is well exfoliated and uniformly dispersed, it has a minimum negative impact on the clarity of the produced nanocomposites.

TABLE 5
Optical Properties of Polystyrene Nanocomposites

| | | 535 + 5% | | 945E + 5% |
|---|---|---|---|---|
| | 535 | CLOISITE 10A | 945E | CLOISITE 10A |
| Gloss, 20° | 158.6 | 80.8 | 45.3 | 59.6 |
| Gloss, 60° | 149.9 | 93.0 | 78.0 | 83.7 |
| Haze | 0.8 | 85.4 | NA | NA |

The results of this experiment confirm that CLOISITE 10A has a higher compatibility with polystyrene than CLOISITE 15A, despite having a lower hydrophobicity. The high compatibility between the nanofiller and polystyrene leads to the formation of an intercalated morphology in the prepared nanocomposites, and subsequently an improved stiffness.

Use of broader terms such as comprises, includes, having, etc. should be understood to provide support for narrower terms such as consisting of, consisting essentially of, comprised substantially of, etc.

The term “affinity” as used herein shall refer to the tendency of a first material to mix or combine with a second material of unlike composition, such as a solvent and a solute. As used herein two materials have an affinity for each other if there is no more than 3.0 (MPa^{1/2}) difference between their solubility parameters.

The term “composite materials” refers to materials which are made from two or more constituent materials (e.g., a layered compound and a polymeric material) with significantly different physical and/or chemical properties and which remain separate and distinct on a macroscopic level within the finished structure.

The term “exfoliation” refers to delamination of a layered materials resulting in the formation of disordered layers or sheets.

The term “nanocomposites” refers to materials that are created by introducing nanoparticulates, also termed filler materials (e.g., a layered compound) into a macroscopic material (e.g., a polymeric material) which is typically referred to as the matrix.

Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

The term “processing” is not limiting and includes agitating, mixing, milling, blending and combinations thereof, all of which are used interchangeably herein. Unless otherwise stated, the processing may occur in one or more vessels, such vessels being known to one skilled in the art.

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Other and further embodiments, versions and examples of the invention may be devised without departing from the basic scope thereof and the scope thereof is determined by the claims that follow.

What is claimed is:

1. A method for production of a polymeric composite having improved intercalated/exfoliated morphology comprising:
combining a monomer with a treated layered compound to form a mixture; and
subjecting the mixture to polymerization conditions to produce a polymeric composite;
wherein the treated layered compound has been formed by treating a layered compound with an organic compound to produce a treated layered compound having an affinity with the monomer prior to combining with the monomer.

2. The method of claim 1, wherein the monomer has a solubility parameter and the treated layered compound has an organic group having a solubility parameter, wherein the difference between the monomer solubility parameter and the organic group solubility parameter is no more than 3.0 (MPa/^{1/2}).

3. The method of claim 1, wherein the treated layered compound comprises at least one hydrocarbon ring group.

4. The method of claim 1, wherein the treated layered compound comprises at least one methacrylate group.

5. The method of claim 1, wherein the layered compound is represented by the formula: 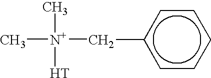
where HT is Hydrogenated Tallow (˜65% C₁₈; ˜30% C₁₆; ˜5% C₁₄)

6. The method of claim 1, wherein the polymer is a styrenic polymer that optionally comprises one or more copolymers.

7. The method of claim 1, further comprising:
adding an additive to the mixture, the additive selected from the group consisting of zinc methacrylate, stearyl methacrylate, hydroxyethylmethylcrylate, or combinations thereof.

8. The method of claim 7, wherein the additive is present in the mixture in the range of 0.01 wt % to 10.0 wt %.

9. The method of claim 1, wherein the monomer is present in an amount of from 50 wt % to 99.9 wt % and the treated layered compound is present in an amount of from 0.1 wt % to 50 wt % of the mixture.

10. The method of claim 1, wherein the polymeric composite has an intercalated morphology, an exfoliated morphology, or both.

11. The method of claim 1, wherein the layered compound has an interlayer distance and the treated layered compound has an interlayer distance and the treated layered compound in the polymer composite has an interlayer distance of at least 5 angstroms greater that the interlayer distance of the layered compound.

12. The method of claim 1, further comprising:
adding an elastomer to the mixture in amounts from 0.1 wt % to 50 wt % by total weight.

13. The method of claim 12, wherein the elastomer comprises conjugated diene monomer, 1,3-butadiene, 2-methyl-1,3-butadiene, 2 chloro-1,3 butadiene, 2-methyl-1,3-butadiene, 2 chloro-1,3-butadiene, aliphatic conjugated diene monomer, C₄ to C₉ dienes butadiene, or combinations thereof.

14. The method of claim 1, wherein the layered compound comprises natural clay, synthetic clay, sols, colloids, gels, fumes, or combinations thereof.

15. The method of claim 1, further comprising:
orienting the polymeric composite to produce an oriented composite;
wherein orienting the composite comprises stretching, spinning, blowing, casting, or combinations thereof in a machine direction, or in a transverse direction, or both.

16. An article produced from the polymeric composite of claim 1.

17. A method comprising:
mixing a polymer with a treated layered compound to form a polymeric composite;
wherein the treated layered compound has been formed by treating a layered compound with an organic compound to produce a treated layered compound having an affinity with the polymer.

18. The method of claim 17, wherein the layered compound is selected from the group consisting of natural clay, synthetic clay, sols, colloids, gels, fumes, or combinations thereof.

19. The method of claim 17, wherein the treated layered compound comprises at least one hydrocarbon ring group.

20. The method of claim 17, wherein the treated layered compound comprises at least one methacrylate group.

21. The method of claim 17, wherein the polymer has a solubility parameter and the treated layered compound has an organic group having a solubility parameter, wherein the difference between the polymer solubility parameter and the organic group solubility parameter is no more than 3.0 (MPa/^{1/2}).

22. The method of claim 17, wherein the layered compound is represented by the formula: 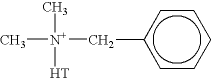
where HT is Hydrogenated Tallow (˜65% C₁₈; ˜30% C₁₆; ˜5% C₁₄)

23. The method of claim 17, wherein the polymer is a styrenic polymer that optionally comprises one or more copolymers.

24. The method of claim 17, wherein the layered compound has an interlayer distance and the treated layered compound has an interlayer distance and the treated layered compound in the polymer composite has an interlayer distance of at least 5 angstroms greater that the interlayer distance of the layered compound.

25. An article produced from the polymeric composite of claim 17.

26. The method of claim 17, wherein the mixing comprises compounding the polymer and the treated layered compound.

27. The method of claim 17, wherein the mixing comprises solution mixing the polymer and the treated layered compound in a solvent.

28. A polymer nanocomposite composition comprising:
a polymer and a treated layered compound;
wherein the treated layered compound has been formed by treating a layered compound with an organic compound to produce a treated layered compound having an affinity with the polymer.

29. The composition of claim 28, wherein the polymer has a solubility parameter and the treated layered compound has an organic group having a solubility parameter, wherein the difference between the polymer solubility parameter and the organic group solubility parameter is no more than 3.0 (MPa/^{1/2}).

30. The composition of claim 28, wherein the layered compound is selected from the group consisting of natural clay, synthetic clay, sols, colloids, gels, and fumes.

31. The composition of claim 28, wherein the treated layered compound comprises at least one hydrocarbon ring group.

32. The composition of claim 28, wherein the treated layered compound comprises at least one methacrylate group.

33. The composition of claim 28, wherein the layered compound is represented by the formula: 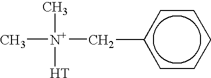
where HT is Hydrogenated Tallow (˜65% C₁₈; ˜30% C₁₆; ˜5% C₁₄)

34. The composition of claim 28, wherein the polymer is a styrenic polymer that optionally comprises one or more copolymers.

35. The composition of claim 28, wherein the layered compound has an interlayer distance and the treated layered compound has an interlayer distance and the treated layered compound in the polymer nanocomposite composition has an interlayer distance of at least 5 angstroms greater that the interlayer distance of the layered compound.

36. An article produced from the polymeric composition of claim 28.
